(19) United States
(12) Patent Application Publication
(10) Pub. No.: US 2007/0039154 A1
(43) Pub. Date: Feb. 22, 2007

(54) Frictional spot joining method and frictional spot joining apparatus

(75) Inventors: Toshiyuki Gendou, Hiroshima (JP); Katsuya Nishiguchi, Hiroshima (JP); Motoyasu Asakawa, Hiroshima (JP); Kenji Takase, Hiroshima (JP); Yohei Shoji, Hiroshima (JP)

Correspondence Address: NIXON PEABODY, LLP, 401 9TH STREET, NW, SUITE 900, WASHINGTON, DC, 20004-2128, US

(73) Assignee: MAZDA MOTOR CORPORATION, Hiroshima (JP)

(21) Appl. No.: 11/488,727

(22) Filed: Jul. 19, 2006

(30) Foreign Application Priority Data
Aug. 2, 2005 (JP) 2005-224457
Aug. 2, 2005 (JP) 2005-224453

(51) Int. Cl. B23Q 17/00; B23Q 3/00

(52) U.S. Cl. 29/407.1; 29/464; 29/709

(57) ABSTRACT

The first and second metal members are joined by being pushed against the interposed member by the rotating tool in a state in which part of the surface of the second metal member corresponding to the joining portion contacts the contacting face of the interposed member that has a larger area than the an area of the tip of the rotating tool. Thus, the first and second metal members can be pressed against the receiving tool of the joining gun via the interposed member. Accordingly, there can be provided a high-quality superior joining product.

### BACKGROUND OF THE INVENTION

The present invention relates to a frictional spot joining method and apparatus in which first and second metal members are provided to lap over, the first metal member is softened and made in a plastic flow state by a frictional heat generated by a rotating tool, whereby the metal members are jointed.

Conventionally, a frictional spot joining in which a lapping portion of first and second metal members is received by a receiving tool, a rotating tool disposed on an opposite side relative to the receiving tool is pushed against the metal members from a side of the first metal member, the first metal member is softened and made in a plastic flow state by a frictional heat generated by the rotating tool, whereby the metal members can be jointed, is known (see, for example, US Patent Application publication No. 2005/0035180 A1).

In particular, the frictional spot joining disclosed in the above-described publication discloses a spot joining of a steel plate having a zinc plating layer thereon and an aluminum plate that lap over. Herein, by the rotating tool being pushed against the steel plate and aluminum plate from a side of the aluminum plate, part of the aluminum plate is softened and made in the plastic flow state, an oxidation film formed on the aluminum plate is destroyed, and the zinc plating layer on the steel plate is pushed out. As a sequence, both new uncovered surfaces of the steel and aluminum plates are joined together in a solid state.

Meanwhile, for the purpose of a weight reduction, a structure using the steel plate and the aluminum plate has been widely applied to a vehicle body or the like of automotive vehicles. Herein, the above-described spot joining is useful to join the steel plate and the aluminum plate. For example, this spot joining may be applied to an aluminum-alloy reinforcement for reinforcing a trunk lid of a vehicle body and a steel bolt retainer equipped with a bolt for attaching a hinge to the trunk lid.

Herein, according to the above-described frictional spot joining, the rotating tool applies a relatively large pressing force to the first and second metal members in a perpendicular direction to their faces. Accordingly, the metal members need to be clamped at a portion other than their support portion. However, an area of a tip of the receiving tool is generally almost the same as that of a tip of the rotating tool or less, and the metal members that lap over are received directly by the receiving tool during the spot joining. Thus, there is a problem that some deformation would occur at the first and second metal members pressed by the rotating tool, thereby providing ill-fitting of the metal members relative to other members.

A modification of the receiving tool having a larger tip area may be useful to prevent the above-described deformation of the metal members. This modification, however, might not work well in cases where the first and second metal members are clamped by a clamping device at adjacent portions of their joining portion, the adjacent portions are not of a flat shape (i.e., rough surfaces), and the spot joining is conducted by a joining robot that has a rotating tool and a receiving tool and is controlled to move as a unit. Because there is a problem that the receiving tool would interfere with the clamp device, so the metal members could not be received properly by the receiving tool. This may be also a problem in case the metal members do not have a large enough flat area to provide a proper joining.

Further, in a case where a metal plating layer (for example, a zinc plating layer) is formed on a surface of the second metal member (for example, a steel plate), when the spot joining is conducted, the metal plating layer is softened or melt with the frictional heat generated by the rotating tool and the second metal member receives a very large pressure from the receiving tool. Thereby, there is a problem that part of the metal plating layer formed on the surface of the second metal member would be separated from that surface, so that a corrosion resistance of the second metal member would deteriorate extremely. Further, the separated part of the metal plating layer from the second metal member would be accumulated on the tip of the receiving member, so that a location of the receiving tool relative to the second metal member would not be properly placed during the spot joining. Thus, there is also a problem that a joining quality of the both metal member would deteriorate. Also, it might be troublesome to provide an additional work step to remove the above-described accumulated metal plating layer.

### SUMMARY OF THE INVENTION

The present invention has been devised in view of the above-described problems, and an object of the present invention is to produce a high-quality superior joining product by properly suppressing the above-described deformation of the first and second metal members by the rotating tool, by properly suppressing the above-described separation of the metal plating layer from the second metal member to maintain the corrosion resistance, and by preventing the above-described deterioration of the joining quality of the metal members.

According to the present invention, there is provided a frictional spot joining method, in which first and second metal members that lap over are jointed substantially in a solid state with a joining gun having a rotating tool and a receiving tool that are disposed to face each other, the second metal member having a higher melting point than the first metal member and a metal plating layer formed on its surface, the rotating tool being configured to be pushed against the first metal member under a rotation such that the first and second metal members are pressed against the receiving tool and the first metal member is softened and made in a plastic flow state by a frictional heat generated by the rotating tool, the method comprising a step of providing an interposed member at a joining portion of the first and second metal members so as to be located on a side of the second metal member, the interposed member and the first and second metal members lapping over being configured to be located between the rotating tool and the receiving tool of the joining gun at a spot joining, the interposed member having a receiving portion located on a side of the rotating tool and a contacting portion located on a side of the receiving tool, the receiving portion being operative to contact the metal plating layer of the second metal member at the spot joining and having an area that is larger than an area of a tip of the rotating tool, the contacting portion being operative to contact the receiving tool of the joining gun at the spot joining, a step of locating the joining gun in a joining position, and a step of pushing the rotating tool under the rotation against the first metal member in a state in which the receiving portion of the interposed member contacts the metal plating layer of the second metal member and the contacting portion of the interposed member contacts the receiving tool of the joining gun, whereby the first and second metal members can be pressed against the receiving tool of the joining gun via the interposed member.

According to the above-described frictional spot joining method, the rotating tool and the receiving tool of the joining gun are located in the joining position and the first and second metal members are pushed against the interposed member by the rotating tool in the state in which the receiving portion of the interposed member contacts the metal plating layer of the second metal member and the contacting portion of the interposed member contacts the receiving tool of the joining gun. Namely, the first and second metal members are pressed against the receiving tool of the joining gun via the interposed member.

Then, part of the metal plating layer on the second metal member is softened by the frictional heat generated by the rotation of the rotating tool, and the softened part of the metal plating layer is pushed out by pushing of the rotating tool, whereby the first and second metal members can be joined substantially in the solid state with substantially no metal plating layer remaining at the joining portion between the first and second metal members.

Accordingly, since the both metal members are pressed against the interposed member by the rotating tool, without a direct contact between the receiving tool having a small area and the second metal member, any improper deformation of the both metal members can be avoided during the pressing and the pressure applied to the second metal member from the interposed member can be reduced properly. Thereby, the first and second metal members can be received by the receiving member surely, so they are spot-joined surely and properly. Also, the metal plating layer on the surface of the second metal member can be prevented from being separated from the metal member's surface by the interposed member, and any accumulation of the separated plating layer on the receiving member and the interposed member can be prevented properly. Thus, a deterioration of corrosion resistance or joining quality of the metal members can be prevented, so a high-quality superior joining product of the metal members can be obtained. Herein, it is preferable that the interposed member is made of metal that has a melting point lower than a temperature of the frictional heat generated at the joining.

Further, it is preferable that the first metal member is an aluminum-alloy plate, the second metal member is a steel plate, and the metal plating layer is a zinc plating layer. Thereby, the zinc plating layer can be prevented from being separated from the steel plate at the spot joining and any accumulation of the separated zinc plating layer on the receiving member can be prevented properly.

Also, according to the present invention, there is provided a frictional spot joining apparatus, in which first and second metal members that lap over are jointed substantially in a solid state with a joining gun having a rotating tool and a receiving tool that are disposed to face each other, the second metal member having a higher melting point than the first metal member and a metal plating layer formed on its surface, the rotating tool being configured to be pushed against the first metal member under a rotation such that the first and second metal members are pressed against the receiving tool and the first metal member is softened and made in a plastic flow state by a frictional heat generated by the rotating tool, the apparatus comprising an interposed member operative to be provided at a joining portion of the first and second metal members so as to be located on a side of the second metal member, the interposed member and the first and second metal members lapping over being configured to be located between the rotating tool and the receiving tool of the joining gun at a spot joining, the interposed member having a receiving portion located on a side of the rotating tool and a contacting portion located on a side of the receiving tool, the receiving portion being operative to contact the metal plating layer of the second metal member at the spot joining and having an area that is larger than an area of a tip of the rotating tool, the contacting portion being operative to contact the receiving tool of the joining gun at the spot joining, a locating device operative to locate the interposed member in a joining position at the spot joining, a rotating-tool drive device operative push the rotating tool under the rotation against the first metal member in a state in which the receiving portion of the interposed member contacts the metal plating layer of the second metal member and the contacting portion of the interposed member contacts the receiving tool of the joining gun, and a moving device operative to move the joining gun between a joining conducting position for conducting the spot joining to the first and second metal members and a standby position away from the joining conducting position, whereby the first and second metal members can be pressed against the receiving tool of the joining gun via the interposed member.

According to the frictional spot joining apparatus, a proper joining apparatus that can perform the above-described frictional spot joining method can be provided. Thereby, substantially the same effects described above can be obtained.

Further, it is preferable that the interposed member comprises a clamping tool that includes a clamp portion to clamp a portion of the second metal member near the joining portion. Also, it is preferable that the interposed member comprises a second clamping tool that includes a clamp portion to clamp a portion of the second metal member near the joining portion, and there is provided a first clamping tool that is provided to face the second clamping tool and includes a clamp portion to clamp a portion of the first metal member near the joining portion.

Thereby, the first and second metal members in the lapping state are clamped at their first and second clamp portions, and herein the receiving portion of the second clamping tool contacts the face of the second metal member at the joining portion. The joining gun is moved by the moving device between the joining conducting position for conducting the spot joining and the standby position away from the joining conducting position. In the state of the joining gun in the joining conducting position, the receiving tool of the joining gun contacts the contacting portion of the second clamping tool, and the rotating tool is rotated and pushed against the first and second metal members by the rotating-tool drive device. Thereby, the first and second metal members are pressed against the receiving tool of the gun and the first metal member is softened and made in a plastic flow state by the frictional heat generated by the rotating tool, so the first and second metal members are joined by the spot joining.

Accordingly, as described above, there are provided the first and second tooling tools, the second tooling tool comprises the receiving portion and the contacting portion with the receiving tool, and there are provided the joining gun and the moving deice. Thereby, the first and second metal members can be surely clamped at the first and second clamp portions of the first and second clamping tool, and the surface of the second metal member at the joining portion (at a joining corresponding portion) can be received properly by the receiving portion of the second clamping tool, so that the both metal members can be pressed against the receiving portion by the rotating tool without any improper deformation of the both metal members and they are spot-joined surely and properly. As a sequence, a high-quality superior joining products of the first and second metal members can be obtained and also a well-fitting of the metal members relative to other members can be provided. Also, since the spot joining is configured to comprise the integrated rotating tool, receiving tool and rotating tool drive device and to be moved by the moving device as a unit between the joining conducting position and the standby position, an efficiency of the joining operation can be improved.

Further, it is preferable that above-described clamping tool comprises the clamp portion and the receiving potion that are formed separately, and there is provided a position adjusting mechanism operative to adjust a relative position of the clamp portion to the receiving portion in a direction perpendicular to a face of the second metal member (joining axis parallel direction) at the joining portion. The position adjusting mechanism may comprise a structure in which the second clamp portion or the receiving portion are provided so as to be movable relative to a base portion of the second clamping tool in the above-described joining axis parallel direction and there is provided a biasing means to bias them toward the second metal member, or a structure in which one or a plurality of spacers with various thickness are provided between the base portion of the second clamping tool and the second clamp portion or the receiving portion of the second clamping tool.

Thereby, since the second clamping tool is comprised of the second clam portion and the receiving portion that are made separately and there are provided the above-described the position adjusting mechanism, even in a case where a position of clamping the metal members is away from a position of joining the metal members and a distance between these positions is improperly changed, the joining portion of the metal members can be received surely and properly by the receiving portion in a state of the metal members clamped at the respective clamp portions.

Further, it is preferable that the first metal member is the aluminum-alloy plate, the second metal member is the steel plate, there are provided a plurality of joining portions at the first and second members, and there are provided a support member to support a part between adjacent joining portions of the first and second members from a side of the first clamping tool.

Thereby, the rotating tool pushes the aluminum-alloy plate and steel plate from the side of the aluminum-alloy plate and thereby the aluminum-alloy plate is softened and made in the plastic flow, so the two plates can be joined such that new uncovered surfaces of the both plates contact each other directly. And, an improper deformation of the aluminum-alloy plate due to a heat expansion can be suppressed properly, so the high-quality joining can be provided.

It is preferable that the above-described moving device is a robot. Thereby, the joining gun can be moved between the joining conduction position and the standby position properly and quickly.

Other features, aspects, and advantages of the present invention will become apparent from the following description which refers to the accompanying drawings.

### BRIEF DESCRIPTION OF THE DRAWINGS

FIG. 1 is a side view of a robot equipped with a joining gun of a frictional spot joining apparatus of an embodiment 1.

FIG. 2 is a side view of the joining gun.

FIG. 3 is a partial sectional view of a major part of a rotating tool.

FIG. 4 is a side view of a work holding device of the frictional spot joining apparatus.

FIG. 5 is a plan view of the work holding device.

FIG. 6 is a partial sectional elevation view of the work holding device.

FIG. 7 is a bottom view of a clamp arm, a second clamping tool and others.

FIG. 8 is a plan view of a support member.

FIG. 9 is a sectional view taken along line IX-IX of FIG. 8.

FIG. 10 is a sectional view taken along line X-X of FIG. 8.

FIG. 11 is a longitudinal sectional view of the second clamping tool, a position adjusting mechanism and others.

FIG. 12 is a longitudinal sectional view of the second clamping tool, the position adjusting mechanism and others.

FIG. 13 is a bottom view of a trunk lid.

FIG. 14 is a longitudinal sectional view of the trunk lid and first and second metal members.

FIG. 15 is a longitudinal sectional view of the trunk lid and first and second metal members.

FIG. 16 is a sectional view when a spot joining is conducted.

FIG. 17 is a sectional view when a spot joining is conducted.

FIG. 18 is a sectional view when the spot joining is conducted.

FIG. 19 is a sectional view when the spot joining is conducted.

FIG. 20 is a longitudinal sectional view of the second clamping tool, a position adjusting mechanism and others of an embodiment 2.

FIG. 21 is a longitudinal sectional view of the second clamping tool, a position adjusting mechanism and others of the embodiment 3.

### DETAILED DESCRIPTION OF THE INVENTION

Hereinafter, preferred embodiments of the present invention will be described referring to the accompanying drawings. It should be understood that even though embodiments are separately described, single features thereof may be combined to additional embodiments.

Embodiment 1

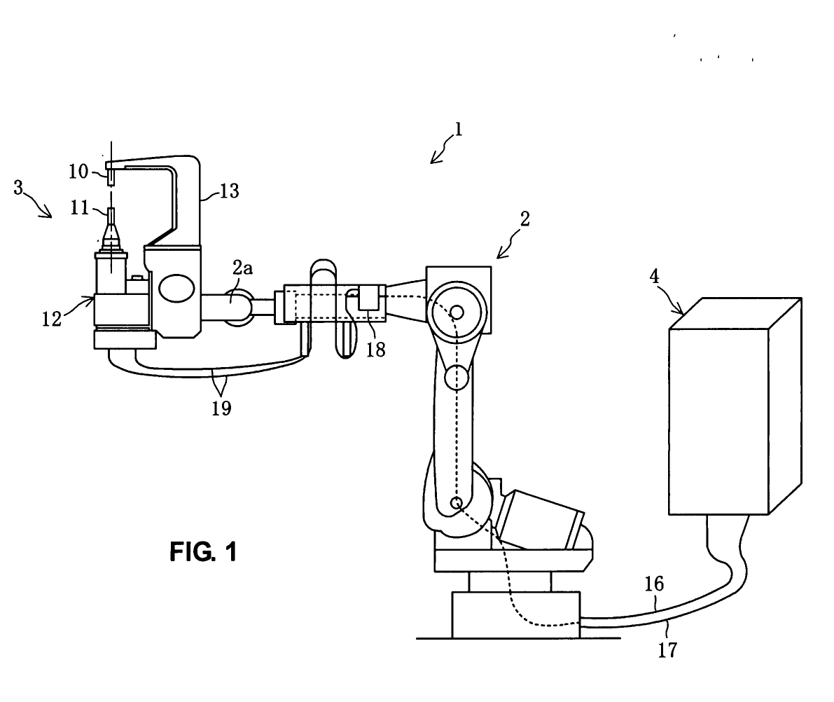

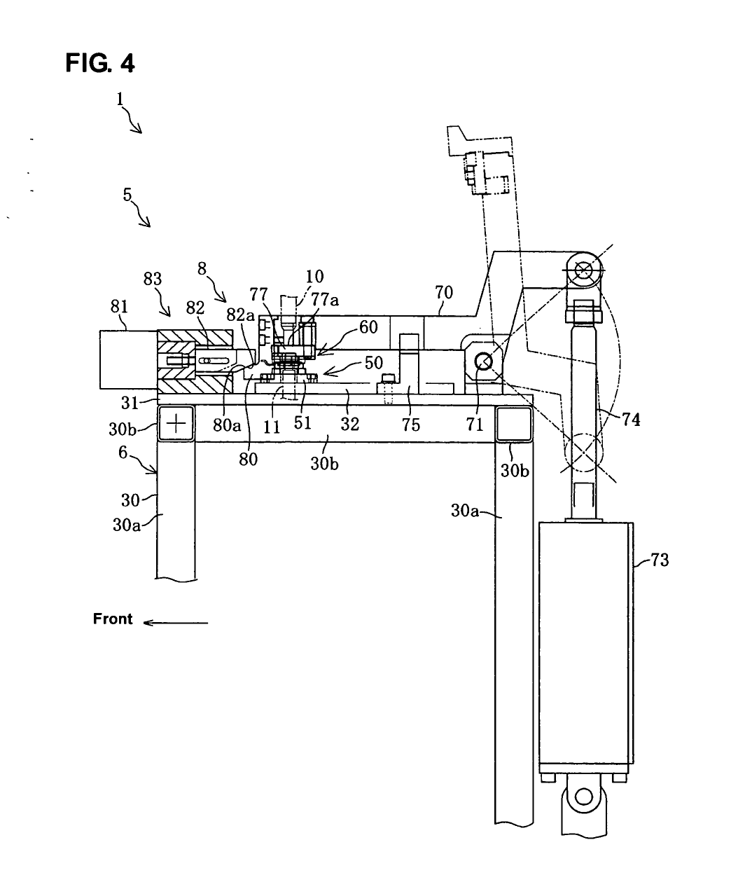

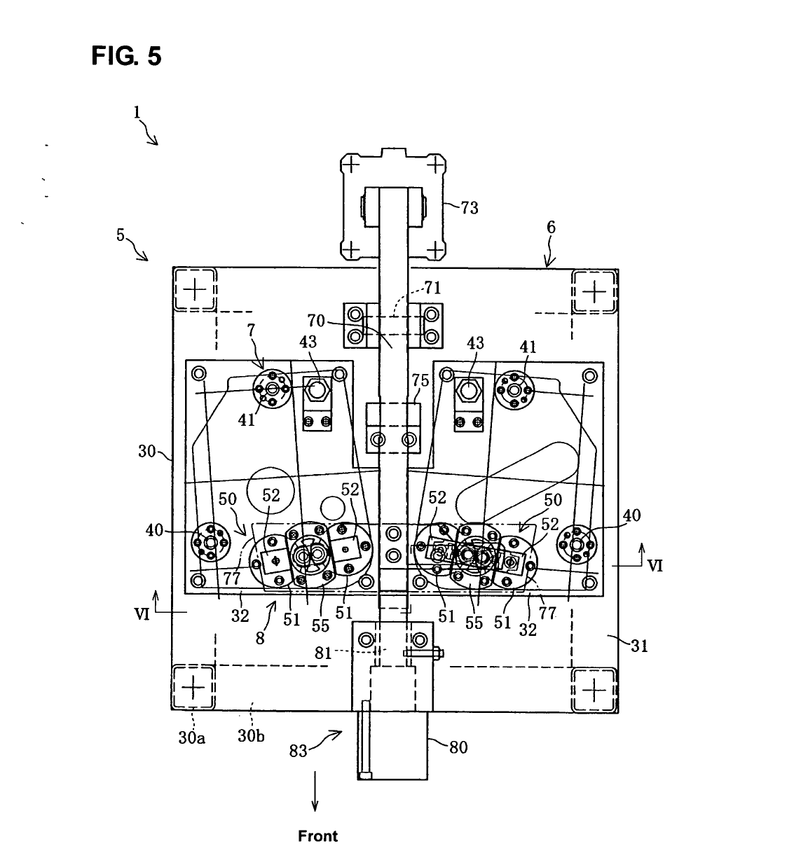

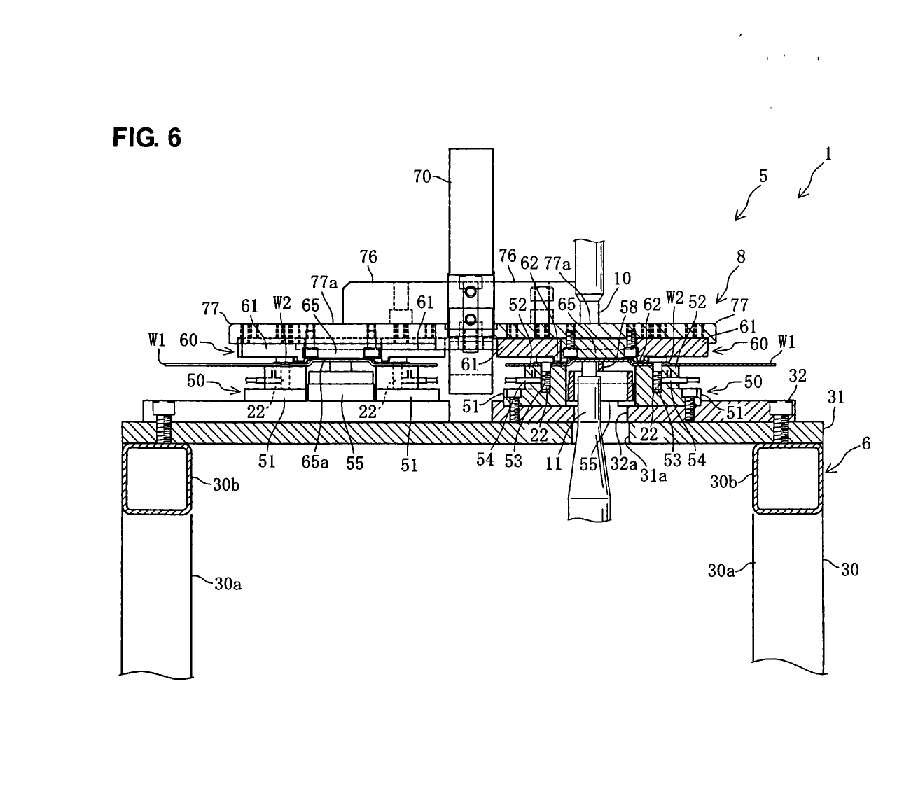

A frictional spot joining apparatus 1 comprises a robot 2 equipped with a joining gun 3 (see FIGS. 1-3), a control device 4 operative to control the robot 2 and the joining gun 3 (see FIG. 1) and a work holding device 5 operative to hold first and second metal members W1, W2 lapping over to be joined by the joining gun 3 in a specified position (see FIGS. 4-6).

As shown in FIG. 1, the robot 2 is, for example, a six-axis multiple-articulated type of robot, and has the joining gun 3 at a tip of a robot hand 2a. The robot 2 moves the joining gun 3 to a joining conducting position for conducting a spot joining to the first and second metal members W1, W2 held by the work holding device 5 in the specified position and to a standby position where it is away from the joining conducting position. Thus, the robot 2 corresponds to a moving device.

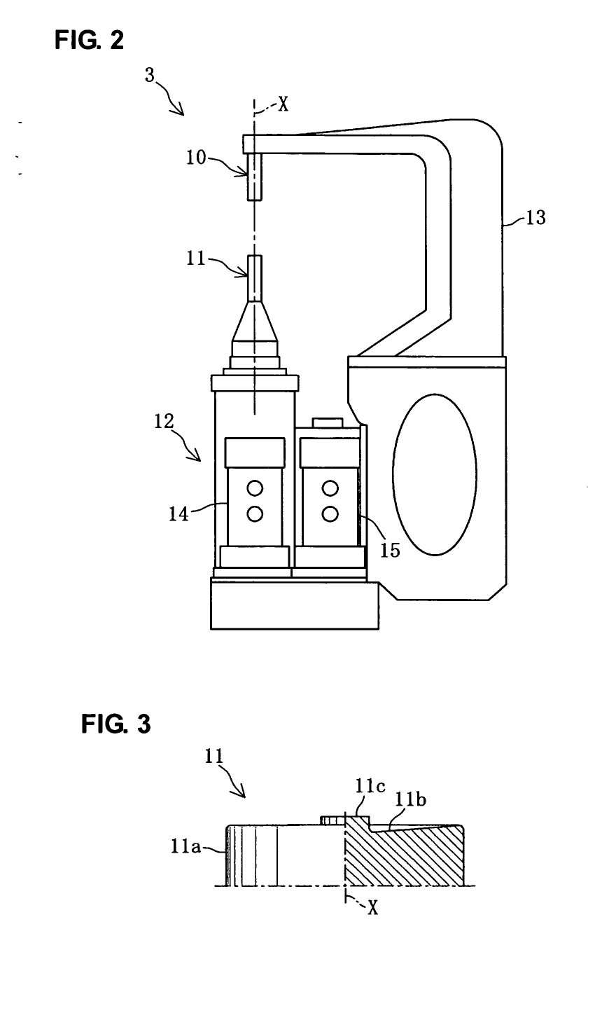

The joining gun 3 comprises a receiving tool 10, a rotating tool 11, and a rotating-tool drive mechanism 12 as shown in FIG. 2. The receiving tool 10 and the rotating tool 11 are disposed vertically so as to face each other. The receiving tool 10 is detachably attached to an upper tip portion of a reverse-L shaped arm 13, and the rotating-tool drive mechanism 12 is provided at a lower portion of the arm 13. The rotating tool 11 is detachably attached to the rotating-tool drive mechanism 12, which comprises a rotating motor 14 operative to rotate the rotating tool 11 around a joining axis X and a going-up-down motor 15 operative to move the rotating tool 11 vertically along the joining axis X and push the tool 11 against the first and second metal members W1, W2.

The rotating tool 11 has a shoulder portion 11b that is formed at a tip face (upper end face) of a body portion 11a as shown in FIG. 3. This shoulder portion 11b is formed to be not flat, but slant with a specified angle, so that it comprises a recess with a cone shape that has its center aligning with the joining axis X. At the center of the shoulder portion 11b is provided a pin portion 11c. The receiving tool 10 has substantially the same diameter as that of the rotating tool 11 and its tip face (lower end face) is formed to be flat.

As shown in FIG. 1, the control device 4 is coupled to various electrical actuators (not illustrated) of the robot 2 via a harness 16 so as to control those actuators. Also, it is coupled to the rotating motor 14 and the going-up-down motor 15 of the joining gun 3 via a harness 17, a junction box 18 and harnesses 19 so as to control those motors 14, 15.

Next, the work holding device 5 will be described. As shown in FIGS. 4-6, the work holding device 5 comprises a work holding table 6, a positing mechanism 7 to place the first and second metal members W1, W2 in the lapping state in a specified position on the work holding table 6, and a clamp mechanism 8 to clamp the metal members W1, W2 placed in the specified position. In FIGS, 4 and 5, a front direction is denoted by an arrow.

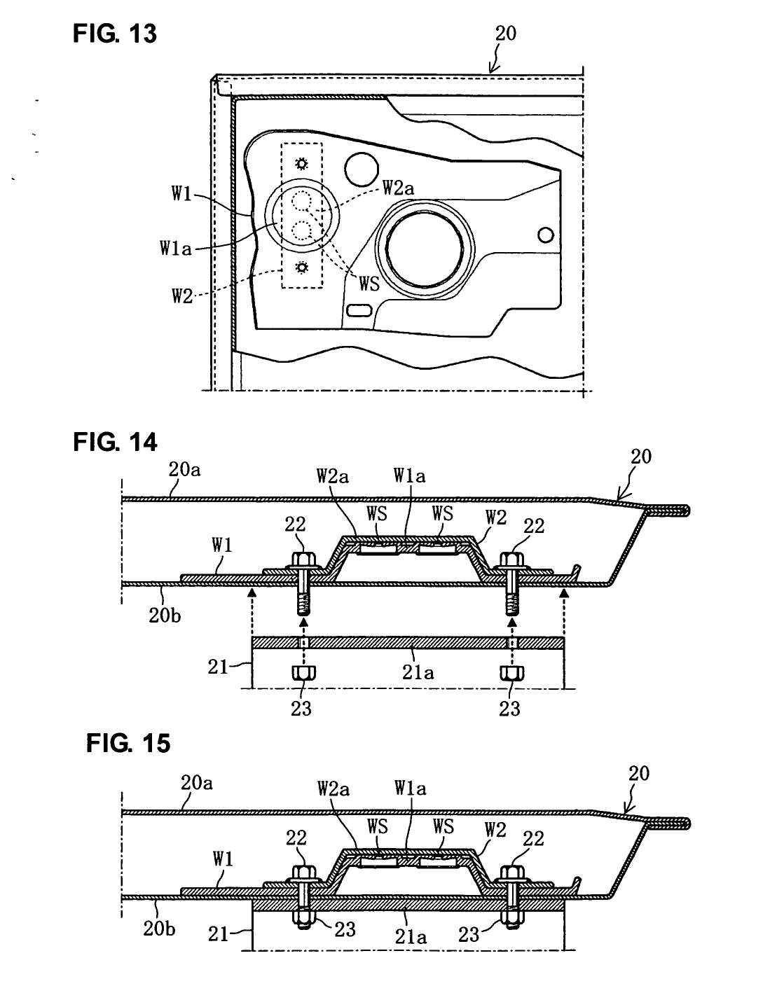

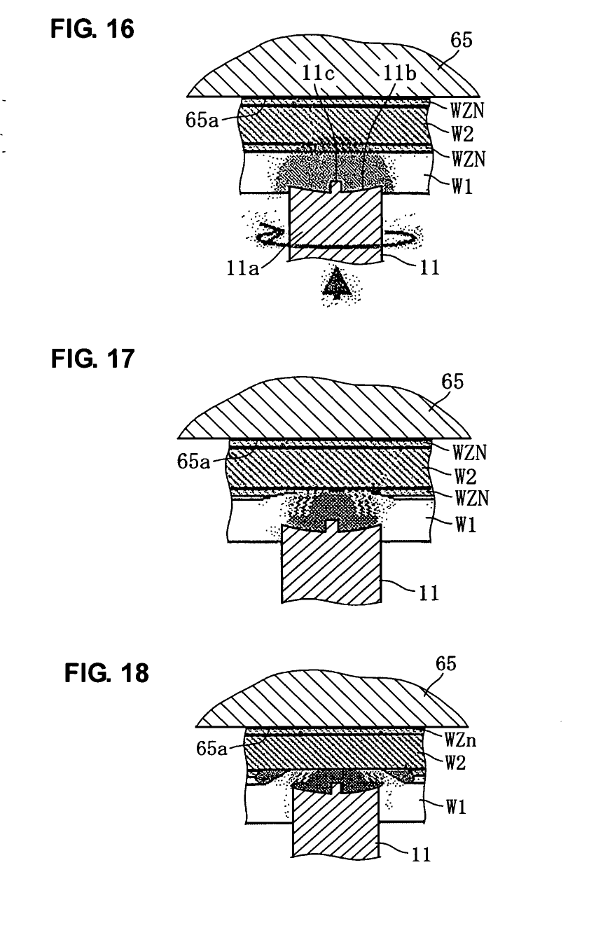

Herein, the first metal member W1 is an aluminum-alloy plate and an oxidation film is formed on its surface. The second metal member W2 is a steel plate whose melting point is higher than that of the aluminum-alloy plate (first metal member W1), and a zinc plating layer WZN having an oxidation prevention function is formed on its surface (see FIGS. 16-19). More specifically, as shown in FIGS. 13-15, the first metal member W1 is exemplified to form an aluminum-alloy reinforcement for reinforcing a trunk lid 20 of a vehicle body, and the second metal member W2 is exemplified to form a steel bolt retainer equipped with a pair of bolts 22 for attaching a hinge 21 to the trunk lid 20. These members W1, W2 are joined by the spot joining, so a joining part comprised of the members W1, W2 is provided. Herein, any metal plating players other than the above-described zinc plating layer WZN may be applied, such as Zn-5 wt % Al plating layer, Al-10 wt % Si plating layer.

The trunk lid 20 comprising an outer panel 20a and an inner panel 20b, and peripheral portions of these panels are connected via a hemming process to form a closed cross section. A pair of the joining parts comprised of the members W1, W2 is attached to an inner face of the inner panel 20b. The first metal member W1 is of a substantially rectangular shape and its size is a little smaller than a half of size of the inner panel 20b. At both outer ends of the first metal member W1 are provided circular projecting portions W1a. Meanwhile, the second metal member W2 is of a plate shape, and at its center portion is provided a projecting portion W2a that corresponds to the projecting portions W1a of the first metal member W1. A pair of bolts 22 for attaching is provided outside the projecting portion W2a.

Most part of the second metal member W2 contacts the first metal member W1, and the projecting portions W1a, W2a are joined by the spot joining at two portions with the bolts 22 being in the penetrating state. The first metal member W1 contacts the inner panel 20b, and the bolts 22 penetrate the inner panel 20b and both plate portions 21a of the hinge 21 contacting an outer face of the inner panel 20b. By fastening nuts 23 to the bolts 22, the hinge 21 and the both metal members W1, W2 are attached firmly to the inner panel 20b.

The work holding device 5, as shown in FIGS. 4-6, is capable to clamp the two pairs of the metal members W1, W2 at the same time by the clamp mechanism 8, placing these members W1, W2 in the specified position by the positing mechanism 7. And, the members W1, W2 clamped this way are joined by the spot joining with the robot 2 and the joining gun 3.

At the work holding table 6 there is provided a table frame 30 comprising a plurality of legs 30a and beams 30b that are connected to each other. A rectangular base plate 31 is fixed on the table frame 30. And, a pair of right and left work placing plates 32 are fixed on the base plate 31. The first metal member W1 is placed on the work placing plates 32 and the second metal member W2 is placed on the first metal member W1.

The positioning mechanism 7 comprises two pairs of positioning pins 40, 41 that are provided so as to project upward at the respective work placing plates 32. The front-side pins 40 are located at outside portions of the work placing plates 32, while the rear-side pins 41 are located at center portions of the work placing plates 32. These positioning pins 40, 41 engage with respective positioning holes formed at the first metal member W1. There are provided accessing sensors 43 operative to detect the first metal member W1 placed on the work placing plates 32 at rear portions of the work placing plates 32 that are located inside the positioning pins 41.

The clamp mechanism 8 comprises two pairs of first and second clamping tools 50, 60 that are provided at both sides for the two pairs of first and second metal members W1, W2. Both side portions of joining portions WS of the respective first and second metal members W1, W2 are clamped by the respective first and second clamping tools 50, 60.

The first clamping tools 50 are provided at the front portions of the work placing plates 32, respectively. Each of the first clamping tools 50 comprises a pair of first clamping members 51 and a support member 55 that is located between the first clamping members 51. These members 51, 55 are of a partially circular shape, when viewed from above, and located in line with their facing vertical faces contacting each other. These members 51, 55 are fixed on the upper face of the work placing plate 32 with bolts.

The first clamping members 51 include first clamp portions 52 that have a relatively large upper face contacting the first metal member W1, respectively. Each of the first clamping members 51 has a bolt hole 53 into which the above-described bolt 22 of the second metal member W2 is inserted from above. This bolt hole 53 works as a positioning function, and can position the first and second metal members W1, W2 properly along with the above-described positioning pins 40, 41. Also, at the respective first clamping members 51 are provided accessing sensors 54 operative to detect the bolts 22 inserted into the bolt holes 32.

Herein, at the base plate 31 and the work placing plate 32 are provided rotational-tool passing holes 31a, 32a. The rotating tool 11 can get through these holes 31a, 32a from below the base plate 31 and conduct the spot joining. The support member 55 is provided above the passing holes 31a, 32a, and the support member 55 includes a support portion 58 to support a part between a pair of adjacent joining portions WS of the members W1, W2 from the side of the first clamping tool 50.

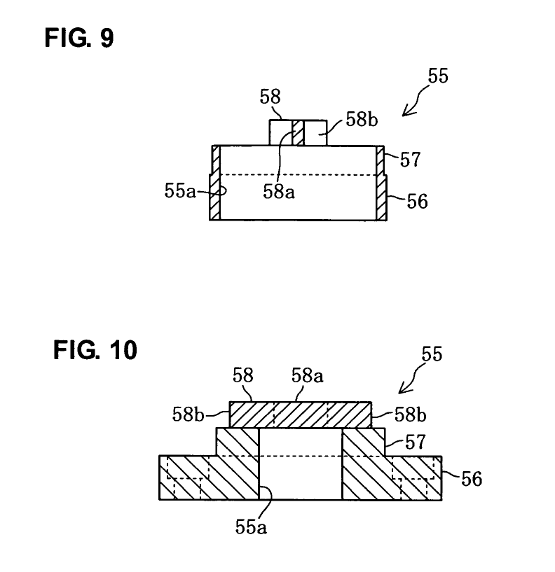

As shown in FIGS. 8-10, the support member 55 comprises a fixed portion 56 for fixing to the work placing plate 32, a circular-shaped projecting portion 57 projecting upward from the fixed portion 56, and a support portion 58 fixed to an upper face of the projecting portion 57. An oval-shaped rotational-tool passing hole 55a are formed at the fixed portion 56 and the projecting portion 57. The rotating tool 11 can get through this hole 55a from below and conduct the spot joining. The support portion 58 comprises a bridge part 58a and a fan-shaped part 58b at both ends, which is formed across the center of the passing hole 55a so as to avoid an interference with the rotating tool 11.

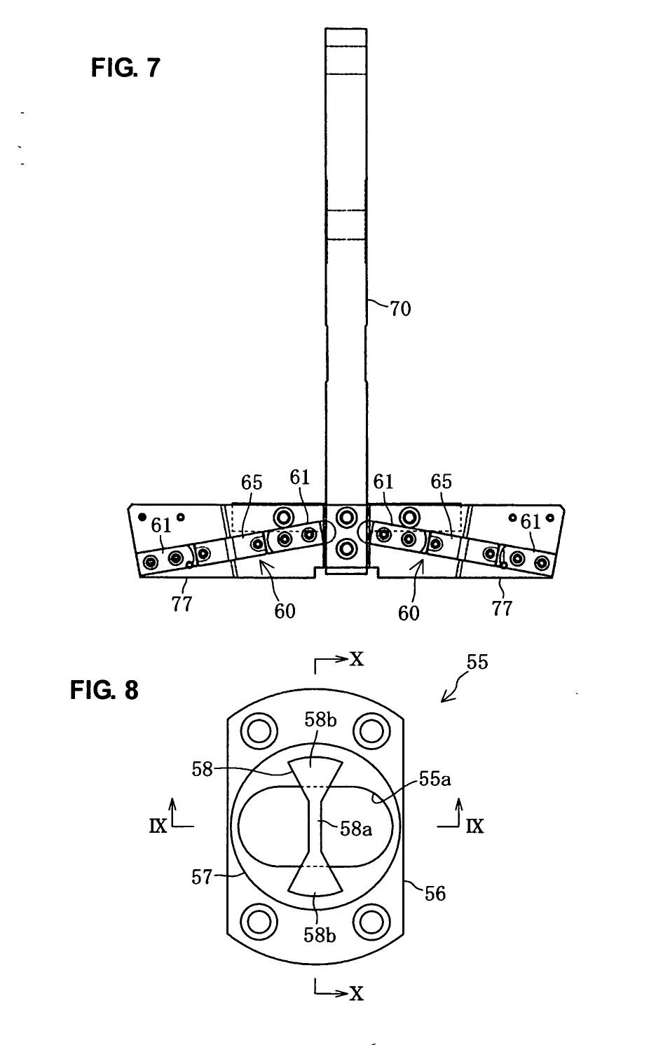

As shown in FIGS. 4-7, a clamp arm 70 is pivotally attached to the central rear portion of the base plate 31 via a pivotal axis 71. The clamp arm 70 can be located above the work placing plate 32, taking its horizontal position where a front end of the clamp arm 70 is positioned near the front end of the base plate 31. The clamp arm 70 extends rearward from the pivotal axis 71, and a front end of a rod 74 of an air cylinder 73 is pivotally coupled to a base end of the clamp arm 70. The base end of the air cylinder 73 is pivotally coupled to the work holding table 6. These clamp arm 70 and air cylinder 73 constitute a locating device operative to locate a second clamping tool 60 (corresponding to an interposed member), which will be described later, in a joining position at the spot joining.

Pressured air is supplied to the air cylinder from the pressured-air supplying device (not illustrated), and the air cylinder 3 is driven with a control of the pressured-air supplying device by the control device 4. Thereby, the clamp arm 70 is selected between its horizontal position and its vertical (upright) position. Herein, a reference numeral 75 denotes a guide member operative to guide the clamp arm 70 around its horizontal position. A pair of connecting members 76 is fixed to the front end of the clamp arm 70, and a pair of clamp bases 77 that are bases of the second clamping tools 60 is fixed to these connecting members 76, respectively.

At each of the respective clamp bases 77 (second clamping tool base) of the second clamping tools 60 (corresponding to an intermediate member) are attached a pair of second clamping members 61 and a receiving member 65 (corresponding to a receiving portion) that is located between these members 61. At each of the clamp bases 77 is provided a contacting portion 77a that the receiving tool 10 contacts when the spot joining is conducted. A pair of second clamping members 61 and the receiving member 65 is respectively formed in a long rectangular shape, when viewed from above, and located in line with their facing vertical faces contacting each other. These members 61, 65 are fixed to the lower face of the clamp base 77 that faces the work placing plate 32 when the clamp arm 70 is in the horizontal position.

The second clamping tools 61 have second clamp portions 62 that project toward the first clamping tool 50 and contact the second metal member W2. The receiving member 65 is made of steel and of a block shape, and it has a contacting face 65a that is larger than an area of the tip (shoulder portion 11b) of the rotating tool 11. This contacting face 65a is configured to contact an upper-face specified area portion of the second metal member W2 that corresponds to the joining portion WS and its peripheral part, so that the first and second metal members W1, W2 can be received by the contacting face 65a during the joining. The above-described specified area portion of the second metal member W2 corresponds to an entire top of the projecting portion W2a of the second metal member W2. Herein, a diameter of the area of the contacting face 65a of the receiving member 65 is 1.2 times as large as a diameter of the shoulder portion 11b of the rotating tool 11 or more, preferably, 1.5 times or more.

For joining the first metal member W1 comprised of the reinforcement and the second metal member W2 comprised of the bolt retainer at their projecting portions W1a, W2a, the receiving member 65 is disposed at a retracted location relative to the second clamping members 61, and the support portion 58 of the support member 55 of the first clamping tool 50 projects upward relative to the first clamping member 51.

At a tip portion of the clamp arm 70 is fixed a pushed member 80 that has a slant-shaped engagement portion 80a that projects toward the tip. When the clamp arm 70 is in the horizontal position, the engagement portion 80a takes a position to be gently slant forward. Meanwhile, an air or hydraulic drive cylinder 81 is attached to a center portion of the front end of the base plate 31, and its output rod 82 engages with a slant-shaped drive portion 82a. This drive portion 82a is configured to be generally slant as shown in FIG. 4 so as to engage or disengage with the engagement portion 80a. The pushed member 80 and the drive cylinder 82 form a clamp drive mechanism 83. This clamp drive mechanism 83 operates and thereby the second clamping tool 60 can be pushed strongly toward the first clamping tool 50.

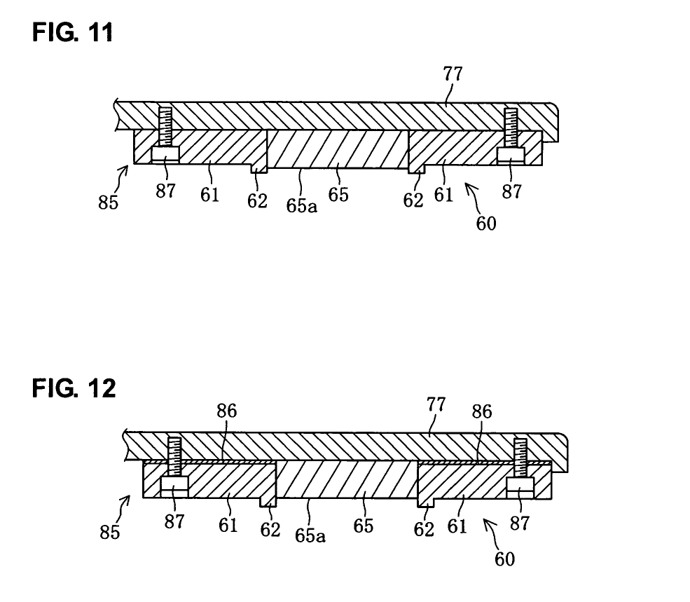

As described above, the second clamping tool 60 comprises a pair of second clamping members 61 having the second clamp portions 62 and the receiving member 65. And, the frictional spot joining apparatus 1 has a position adjusting mechanism 85 (see FIGS. 11 and 12), which can adjust a relative position of the second clamp portions 62 to the contacting face 65a of the receiving member 65 in a direction perpendicular to the faces of the metal members W1, W2 at the joining portion WS (a joining axis parallel direction).

As shown in FIGS. 11 and 12, the position adjusting mechanism 85 comprises shims (spacers) 86 operative to be inserted between the clamp base 77 and the second clamp members 61. Accordingly, there can be two state where the members 61 are fixed to the clamp base 77 by bolts 87 without any shims 86 as shown in FIG. 11, and the members 61 are fixed with the shims 86 as shown in FIG. 12. Also, by using a plurality of shims 86 lapping over or different thickness of shims 86, the relative position of the second clamp portion 62 to the contacting face 65a can be changed properly.

Next, the frictional spot joining method executed by the joining apparatus 1 will be described.

First, the first and second metal members W1, W2 are set on the work placing plate 32 when the clamp arm 70 is in the upright position, i.e., the second clamping tool 60 is away from the first clamping tool 50. Herein, the metal members W1, W2 are let be in the lapping state, the pins 40, 41 are let engage with the positioning holes of the first metal member W1, and the bolts 22 fixed to the second metal member W2 are let be inserted into the bolt holes 53 of the first metal member 50. Thereby, the positioning of the members W1, W2 is done.

Next, the clamp arm 70 is moved to the horizontal position from the upright position by the drive of the air cylinder 73. Subsequently, the first and second metal members W1, W2 are clamped by the first and second clamping tools 50, 60 with the operation of the clamp drive mechanism 83. Herein, the both-side portions of the joining portions WS of the metal members W1, W2 (flat portions at both sides of the projecting portion W1a, W2a) are pushed (pressed) toward the first clamp portion 52 and thereby these members W1, W2 are clamped.

In this state, the contacting face 65a of the receiving member 65 of the second clamping tool 60 contacts the upper-face specified area portion of the second metal member W2 that corresponds to the joining portion WS and its peripheral part. And, portions of the metal members W1, W2 located between the adjacent joining portions WS are supported by the support portion 58 of the support member 55 of the first clamping tool 50.

Next, the spot joining is conducted to first and second metal members W1, W2 by the operation of the joining gun 3 and the robot 2. Herein, the joining gun 3 is moved to the joining position from the standby position by the robot 2. And, the receiving tool 10 of the joining gun 3 is moved from above and contacts the contacting portion 77a of the clamp base 77, and the rotating tool 11 is positioned below the joining portions SW of the metal members W1, W2.

Subsequently, the rotating tool 11 is rotated by the rotating tool drive mechanism 12, and contacts the first metal member W1 and then pushes (presses) the both metal members W1, W2 against the receiving member 65. Herein, the receiving tool 10 functions so as to receive the metal members W1, W2 pushed by the rotating tool 11 via the clamp base 77 and the receiving member 65. And, at least the first metal member W1 is softened and made in a plastic flow state by the frictional heat generated through contacting and rotating of the tool 11 against the first metal member W1. Thereby, the spot joining is conducted.

Hereinafter, the spot joining will be described. According to increasing of the rotating tool 11, the pin portion 11c of the rotating tool 11 is positioned properly at a specified portion on the first metal member W1. Then, as shown in FIG. 16, the shoulder portion 11b contacts the first metal member W1, which come to be softened by the frictional heat. Subsequently, as the rotating tool 4 increases the rotational speed, as shown in FIG. 17, the rotating tool 11 proceeds further into the softened first metal member W1. Herein, part of the first metal member W1, where a contact pressure with the rotating tool 11 becomes very high, is stirred. The zinc plating layer WZN formed on the surface of the second metal member W2 also comes to be softened by receiving the frictional heat, and is diffused into the above-described stirred part of the first metal member W1.

Subsequently, as shown in FIG. 18, according to pressing of the rotating tool 11, the shoulder portion 11b proceeds further and a plastic flow (plastic deformation) is generated at the first metal member W1. At the same time, the softened zinc plating layer WZN that remains at the boundary face between the first and second metal members W1, W2 is pushed out. Herein, the oxidation film formed on the surface of the first metal member W1 is destroyed with the plastic deformation due to its rather weakness, so that a new uncovered surface of the first metal member W1 is exposed.

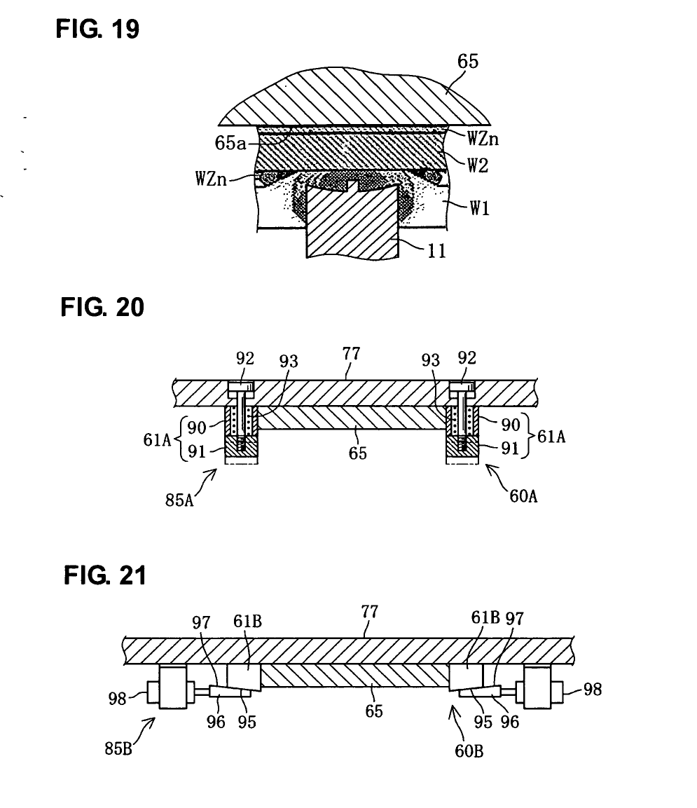

Further, as shown in FIG. 19, part of the zinc plating layer WZN on the surface of the second metal member W2 is captured into the first metal member W1, and the rest of it is pushed out toward around the joining portion WS by the pressing force of the rotating tool 11. Accordingly, in an area where the zinc plating layer WZN is removed, the above-described new uncovered surface of the first metal member W1 and a new surface of the second metal member W2 contact each other directly (joining in a solid state). And, at a peripheral area where the zinc plating layer WZN remains, the first and second metal members W1, W2 are joined via a zinc-aluminum-iron compound.

The above-described frictional spot jointing apparatus 1 and frictional spot joining method perform the following effects. Since the both metal members W1, W2 are pressed against the receiving member 65 by the rotating tool 11, without the direct contact between the receiving tool 11 having the small area and the second metal member W2, any improper deformation of the both metal members W1, W2 can be avoided during the pressing and the pressure applied to the second metal member W2 from the receiving member 65 can be reduced properly. Thereby, the first and second metal members W1, W2 can be received by the receiving member 65 surely, so they are spot-joined surely and properly. Also, the zinc plating layer WZN on the surface of the second metal member W2 can be prevented from being separated from the metal member's surface by the receiving member 65, and any accumulation of the separated plating layer on the receiving member 65 can be prevented properly. Thus, the deterioration of corrosion resistance or joining quality of the metal members W1, W2 can be prevented, so the high-quality superior joining product of the metal members W1, W2 can be obtained.

When the zinc plating layer WZN of the second metal member W2 on the side of the second clamping tool 60 is heated by the frictional heat produced by the contact between the rotating tool 11 and the first metal member W1, this heat is radiated from the receiving member 65 that has the larger contacting face 65a than the joining portion WS. Thereby, the heat radiation can be improved, thereby properly preventing the zinc plating layer WZN on the side of the second clamping tool 60 from being softened. Also, since the state of contacting between the receiving member 65 and the zinc plating layer WZN can be maintained for a specified period of time from the spot joining, the stationary fixing of the zinc plating layer WZN on the side of the second clamping tool 60 can be improved, so the separation of the plating layer WZN can be prevented as well.

Further, since the first metal member W1 is the aluminum-alloy reinforcement for reinforcing the trunk lid 20 of the vehicle body and the second metal member W2 is the steel bolt retainer equipped with the bolts 22 for attaching the hinge 21 to the trunk lid 20 in the present embodiment, those spot joining can be conducted properly and thus the high-quality joining product of the reinforcement and bolt retainer can be obtained.

Herein, the position adjusting mechanism 85 may be configured to be selectable between states where the receiving members 65 are fixed to the clamp base 77 by bolts without any shims located between them and where the members 65 are fixed with the shims located between them. Also, by using a plurality of shims lapping over or different thickness of shims, the relative position of the second clamp portions 62 to the receiving members 65 can be changed properly.

Embodiment 2

In an embodiment 2, the second clamping tool 60 and the position adjusting mechanism 85 of the embodiment 1 are modified. The other parts are the same as those of the embodiment 1 and so their descriptions are omitted here. As shown in FIG. 20, a second clamping tool 60A of the present embodiment includes a pair of second clamping members 61A and the similar receiving member 65, and each of the second clamping members 61A comprises a base portion 90 and a second clamping portion 91 that fixed to the base portion 90. In a position adjusting mechanism 85A of the present embodiment, the second clamp portion 91 is connected so as to be movable relative to the base portion 90 in the above-described joining axis parallel direction and to be biased in a direction opposite to the clamp base 77 by a biasing member 93.

Herein, respective tips of connecting bolts 92 are screwed into the second clamping portions 91, the connecting bolts 92 are inserted through the base portions 90 and the clamp base so as to slide therein, and heads of the connecting bolts 92 are engaged in engagement holes formed at the clamp base 77 located so as to move in the holes. The biasing members 93 (e.g., coil spring) are disposed within the base portion 90 to push the second clamp portion 91 against the base portion 90.

The biasing members 93 are strong enough to adjustably change relative positions between the second clamp portions 91 and the receiving members 65 in the joining axis parallel direction and to strongly push the first and second metal members W1, W2 in any position. Herein, the second clamping member may be fixed to the clamp base 77, the receiving member 65 may be connected so as to be movable relative to the clamp base 77 in the joining axis parallel direction and to be biased in a direction opposite to the clamp base 77 by the biasing member.

Embodiment 3

In an embodiment 3, the second clamping tool 60 and the position adjusting mechanism 85 of the embodiment 1 are modified likewise, and the other parts are the same as those of the embodiment 1 and so their descriptions are omitted here. As shown in FIG. 21, a second clamping tool 60B of the present embodiment includes a pair of second clamping members 61B and the similar receiving member 65. Each second pressing portion 95 of the second clamping members 61B has a slant face. A position adjusting mechanism 85A of the present embodiment includes wedge members 96 having a slant face 97 that slides laterally and contact the second pressing portions 95 respectively and actuators 98 (e.g., air cylinder, electric motor) to move the respective wedge portions 96.

Embodiment 4

Although an illustration is omitted here, in a case where the relative position between the second clamp portion and the contacting face of the receiving member in the direction perpendicular to the faces of the metal members W1, W2 corresponding to the joining portions WS is adjusted by the above-described position adjusting mechanisms 85, 85A and 85B, it is preferable that the support position of the first metal member W1 by the support member 55. In this case, there may be provided a position adjusting mechanism, which is similar to the mechanisms 85, 85A and 85B, operative to adjust the relative position between the first clamp portion 52 and the support portion 58 in the joining axis parallel direction.

The present invention should not be limited to the above-described embodiments, and any other modifications and improvements may be applied within the scope of a sprit of the present invention.

What is claimed is:

1. A frictional spot joining method, in which first and second metal members that lap over are jointed substantially in a solid state with a joining gun having a rotating tool and a receiving tool that are disposed to face each other, the second metal member having a higher melting point than the first metal member and a metal plating layer formed on its surface, the rotating tool being configured to be pushed against the first metal member under a rotation such that the first and second metal members are pressed against the receiving tool and the first metal member is softened and made in a plastic flow state by a frictional heat generated by the rotating tool, the method comprising:
a step of providing an interposed member at a joining portion of the first and second metal members so as to be located on a side of the second metal member, the interposed member and the first and second metal members lapping over being configured to be located between the rotating tool and the receiving tool of the joining gun at a spot joining, the interposed member having a receiving portion located on a side of the rotating tool and a contacting portion located on a side of the receiving tool, the receiving portion being operative to contact the metal plating layer of the second metal member at the spot joining and having an area that is larger than an area of a tip of the rotating tool, the contacting portion being operative to contact the receiving tool of the joining gun at the spot joining;
a step of locating the joining gun in a joining position; and
a step of pushing the rotating tool under the rotation against the first metal member in a state in which the receiving portion of the interposed member contacts the metal plating layer of the second metal member and the contacting portion of the interposed member contacts the receiving tool of the joining gun,
whereby the first and second metal members can be pressed against the receiving tool of the joining gun via the interposed member.

2. The frictional spot joining method of claim 1, wherein part of the metal plating layer on the second metal member is softened by a frictional heat generated by the rotation of the rotating tool, and the softened part of the metal plating layer is pushed out by pushing of the rotating tool, whereby the first and second metal members can be joined substantially in the solid state with substantially no metal plating layer remaining at the joining portion between the first and second metal members.

3. The frictional spot joining method of claim 1, wherein said first metal member is an aluminum-alloy plate, said second metal member is a steel plate, and said metal plating layer is a zinc plating layer.

4. A frictional spot joining apparatus, in which first and second metal members that lap over are jointed substantially in a solid state with a joining gun having a rotating tool and a receiving tool that are disposed to face each other, the second metal member having a higher melting point than the first metal member and a metal plating layer formed on its surface, the rotating tool being configured to be pushed against the first metal member under a rotation such that the first and second metal members are pressed against the receiving tool and the first metal member is softened and made in a plastic flow state by a frictional heat generated by the rotating tool, the apparatus comprising:
an interposed member operative to be provided at a joining portion of the first and second metal members so as to be located on a side of the second metal member, the interposed member and the first and second metal members lapping over being configured to be located between the rotating tool and the receiving tool of the joining gun at a spot joining, the interposed member having a receiving portion located on a side of the rotating tool and a contacting portion located on a side of the receiving tool, the receiving portion being operative to contact the metal plating layer of the second metal member at the spot joining and having an area that is larger than an area of a tip of the rotating tool, the contacting portion being operative to contact the receiving tool of the joining gun at the spot joining;
a locating device operative to locate said interposed member in a joining position at the spot joining;
a rotating-tool drive device operative push the rotating tool under the rotation against the first metal member in a state in which the receiving portion of the interposed member contacts the metal plating layer of the second metal member and the contacting portion of the interposed member contacts the receiving tool of the joining gun; and
a moving device operative to move the joining gun between a joining conducting position for conducting the spot joining to the first and second metal members and a standby position away from the joining conducting position,
whereby the first and second metal members can be pressed against the receiving tool of the joining gun via the interposed member.

5. The frictional spot joining apparatus of claim 4, wherein said interposed member comprises a clamping tool that includes a clamp portion to clamp a portion of the second metal member near the joining portion.

6. The frictional spot joining apparatus of claim 5, wherein said clamping tool comprises said clamp portion and said receiving potion that are formed separately, and there is provided a position adjusting mechanism operative to adjust a relative position of the clamp portion to the receiving portion in a direction perpendicular to a face of the second metal member at the joining portion.

7. The frictional spot joining apparatus of claim 4, wherein said interposed member comprises a second clamping tool that includes a clamp portion to clamp a portion of the second metal member near the joining portion, and there is provided a first clamping tool that is provided to face the second clamping tool and includes a clamp portion to clamp a portion of the first metal member near the joining portion.

8. The frictional spot joining apparatus of claim 7, wherein said first metal member is an aluminum-alloy plate, said second metal member is a steel plate, there are provided a plurality of joining portions at the first and second members, and there are provided a support member to support a part between adjacent joining portions of the first and second members from a side of the first clamping tool.

9. The frictional spot joining apparatus of claim 4, wherein said moving device is a robot.
